(19) United States
(12) Patent Application Publication
(10) Pub. No.: US 2015/0120220 A1
(43) Pub. Date: Apr. 30, 2015

(54) Detecting IC Reliability Defects

(71) Applicant: KLA-Tencor Corporation, Milpitas, CA (US)

(72) Inventors: Joanne Wu, Sunnyvale, CA (US); Ellis Chang, Saratoga, CA (US); Lisheng Gao, Morgan Hill, CA (US); Satya Kurada, Fremont, CA (US); Allen Park, San Jose, CA (US); Raghav Babulnath, San Jose, CA (US)

(21) Appl. No.: 14/512,446

(22) Filed: Oct. 12, 2014

Related U.S. Application Data
(60) Provisional application No. 61/897,115, filed on Oct. 29, 2013.

(51) Int. Cl. G01N 21/95

(52) U.S. Cl. CPC G01N 21/9501; G01N 2201/105; G01N 2201/06106
USPC 702/58

(57) ABSTRACT

Methods and systems for detecting reliability defects on a wafer are provided. One method includes acquiring output for a wafer generated by an inspection system. The method also includes determining one or more geometric characteristics of one or more patterned features formed on the wafer based on the output. In addition, the method includes identifying which of the one or more patterned features will cause one or more reliability defects in a device being formed on the wafer based on the determined one or more characteristics.

### BACKGROUND OF THE INVENTION

1. Field of the Invention

This invention generally relates to methods and systems for detecting reliability defects on wafers.

2. Description of the Related Art

The following description and examples are not admitted to be prior art by virtue of their inclusion in this section.

Semiconductor devices such as integrated circuits (ICs) are formed on wafers using a number of different fabrication processes. After the devices have been formed on the wafers, the devices are usually tested electrically to determine if the devices function in the proper manner. One of the most popular test methods is the leakage current or IDDQ test, i.e., measuring the elevated leakage current to identify a defective chip. Leakage current-based testing is used to screen devices for high reliability applications. The traditional method of ensuring high reliability of chips is the burn-in test. Rigorous studies on the reliability were only done with the circuit level simulations without fully comprehending process variability impact at the wafer level.

As transistor geometries continue to shrink, the intrinsic leakage current of a transistor increases tremendously. It makes distinguishing fault-free and faulty IDDQ extremely difficult, which will result in false rejects (causing yield loss) and false accepts (escaping test). Due to the simple nature of test generation, leakage current testing only indicates if there are reliability defects. Leakage current is not directly correlated to defect types. As such, the root causes of reliability issues cannot be well understood, mitigated, and resolved. Burn-in testing is applied to products as they are made, but not at the component level and the transistor level. Leakages dominate burn-in power.

Accordingly, it would be advantageous to develop systems and/or methods that do not have one or more of the disadvantages described above.

### SUMMARY OF THE INVENTION

The following description of various embodiments is not to be construed in any way as limiting the subject matter of the appended claims.

One embodiment relates to a computer-implemented method for detecting reliability defects on a wafer, The method includes acquiring output for a wafer generated by an inspection system. The method also includes determining one or more characteristics of one or more patterned features formed on the wafer based on the output. In addition, the method includes identifying which of the one or more patterned features will cause one or more reliability defects in a device being formed on the wafer based on the determined one or more characteristics. The acquiring, determining, and identifying steps are performed by a computer system.

The method described above may be performed as described further herein. In addition, the method described above may include any other step(s) of any other method(s) described herein. Furthermore, the method described above may be performed by any of the systems described herein.

Another embodiment relates to a non-transitory computer-readable medium storing program instructions executable on a computer system for performing a computer-implemented method for detecting reliability defects on a wafer. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

An additional embodiment relates to a system configured to detect reliability defects on a wafer. The system includes an inspection subsystem configured to generate output for a wafer. The system also includes a computer subsystem configured for performing the determining and identifying steps of the method described above. The system may be further configured as described herein.

### BRIEF DESCRIPTION OF THE DRAWINGS

Other objects and advantages of the invention will become apparent upon reading the following detailed description and upon reference to the accompanying drawings in which:

FIG. 1 is a flow chart illustrating one embodiment of a computer-implemented method for detecting reliability defects on a wafer;

FIG. 2 is a block diagram illustrating one embodiment of a non-transitory computer-readable medium that includes program instructions executable on a computer system for performing one or more of the computer-implemented methods described herein; and

FIG. 3 is a schematic diagram illustrating a side view of one embodiment of a system configured to detect reliability defects on a wafer.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein provide novel approaches to detecting integrated circuit (IC) reliability defects through wafer in-line leakage signature and via resistance index analysis. One embodiment relates to a computer-implemented method for detecting reliability defects on a wafer. The embodiments described herein can be used to systematically detect IC reliability defects (including latent reliability defects) with various inspection and defect review tools such as those described further herein. In addition, the embodiments described herein enable systematic discovery of leakage signature and potential failure of interconnects with unprecedented sensitivity and precision to help users accelerate their transitions to 1 Xnm and below technology nodes. The embodiments described herein can also be used to create a technique to quantitatively extract leakage signature and via resistance index. Furthermore, the embodiments described herein can report reliability defects in any suitable wafer inspection file format such as KLARF files or encrypted inspection results.

The terms “design” and “design data” as used herein generally refer to the physical design (layout) of an IC and data derived from the physical design through complex simulation or simple geometric and Boolean operations. The design may be stored in a data structure such as a GDS or ASCii file, any other standard machine-readable file, any other suitable file known in the art, and a design database. For all intents and purposes term “GDS” is used for a GDSII file. Other examples of such files include GL1 and OASIS files. The design used in the embodiments described herein may be stored in any of this entire class of files irrespective of data structure configuration, storage format, or storage mechanism.

An image of a reticle acquired by a reticle inspection system and/or derivatives thereof can also be used as a “proxy” or “proxies” for the design. Such a reticle image or a derivative thereof can serve as a substitute for the design layout in any embodiments described herein that use a design. The design may include any other design data or design data proxies described in commonly owned U.S. Pat. No. 7,570,796 issued on Aug. 4, 2009 to Zafar et al. and U.S. Pat. No. 7,676,077 issued on Mar. 9, 2010 to Kulkarni et al., both of which are incorporated by reference as if fully set forth herein. In addition, the design data can be standard cell library data, integrated layout data, design data for one or more layers, derivatives of the design data, and full or partial chip design data.

In general, however, the design information or data cannot be generated by imaging a wafer with a wafer inspection system. For example, the design patterns formed on the wafer may not accurately represent the design for the wafer and the wafer inspection system may not be capable of generating images of the design patterns formed on the wafer with sufficient resolution such that the images could be used to determine information about the design for the wafer. Therefore, in general, the design information or design data cannot be generated using a physical wafer. In addition, the “design” and “design data” described herein refers to information and data that is generated by a semiconductor device designer in a design process and is therefore available for use in the embodiments described herein well in advance of printing of the design on any physical wafers.

The method includes acquiring output for a wafer generated by an inspection system. In one embodiment, the inspection system is a light-based inspection system, and a light source of the inspection system used for generating the output is a broadband plasma (BBP) light source. Therefore, the output used in the embodiments described herein may be generated by inspection systems that may be, generally, referred to as BBP wafer inspection tools. In this manner, the inspection tool may be an optical inspection tool. However, the inspection system may be an electron beam-based inspection system. The inspection system may include any suitable commercially available light- or electron beam-based inspection system known in the art. In addition, the light-based inspection system may be a bright field (BF) and/or dark field (DF) inspection system. In this manner, the inspection system that generates the output used in the embodiments described herein is not limited to BF, DF, and/or electron beam inspection. In other words, the embodiments described herein are independent of the inspection system platform.

Acquiring the output may include scanning light over the wafer and generating output (e.g., images or image data) responsive to light from the wafer detected by the inspection system during the scanning. In this manner, acquiring the output may include scanning the wafer. However, acquiring the output does not necessarily include scanning the wafer. For example, acquiring the output may include acquiring the output from a storage medium in which the output has been stored (e.g., by the inspection system). Acquiring the output from the storage medium may be performed in any suitable manner, and the storage medium from which the output is acquired may include any of the storage media described herein.

The method includes determining one or more characteristics of one or more patterned features formed on the wafer based on the output. For example, the images, image data, or any other output generated by the inspection system may be used to determine one or more of any of the characteristics of the patterned features described further herein. In one such example, images or image data generated by an inspection system may be used to determine one or more dimensions of one or more patterned features formed on the wafer. The one or more characteristics may be determined based on the output of the inspection system using any suitable method and/or algorithm.

In some embodiments, the one or more patterned features include one or more structures of one or more transistors of the device, and the one or more determined characteristics include a dimension of a gate, an area of a source or drain, or a perimeter of a source or drain. In this manner, the embodiments described herein may be performed using transistor geometrical variations such as gate effective channel length, L, width, W, source/drain area and perimeter.

In an additional embodiment, the one or more patterned features include one or more structures of one or more interconnect vias of the device, and the one or more determined characteristics include interconnect via enclosure or area. In this manner, the embodiments described herein may be performed using interconnect via geometrical variations such as via enclosure and area.

In some embodiments, the determined one or more characteristics include one or more differences between one or more measured values of the one or more characteristics of the one or more patterned features formed on the wafer and one or more design values of the one or more characteristics of the one or more patterned features in a design for the wafer. For example, characteristic(s) of patterned features may be determined based on the output as described above to provide one or more measured values of the characteristic(s). Those characteristic(s) may then be subtracted from the as-designed values, which may be determined from any of the design or design data described above, or vice versa to determine the one or more characteristics. In addition, the differences between the measured values and the as-designed values may be determined as described further herein (e.g., using scanning electron microscope (SEM) image to GDS overlay analysis).

The method further includes identifying which of the one or more patterned features will cause one or more reliability defects in a device being formed on the wafer based on the determined one or more characteristics. In another embodiment, the identifying step includes determining one or more characteristics of the device based on the determined one or more characteristics of the one or more patterned features and determining if the one or more characteristics of the device will cause a reliability defect in the device. For example, the one or more characteristics of the patterned feature(s) may be input to a function or algorithm that defines a relationship between the one or more characteristics and one or more characteristics of the device. In one such example, the W and L of a gate, which are determined as described herein, may be input to an equation for sub-threshold leakage current, which may include any suitable equation known in the art, to determine what the sub-threshold leakage current would be for that gate. In another such example, the thickness of a gate oxide layer, which may be determined as described herein, may be input to an equation for gate oxide leakage current, which may include any suitable equation known in the art, to determine what the gate oxide leakage current would be for a transistor that includes that gate oxide layer. In this manner, the device characteristic(s) can be quantitatively determined directly from the characteristic(s) of the patterned feature(s) determined from the inspection system output as described herein. The device characteristic(s) determined for the patterned feature(s) can then be analyzed to determine if those patterned feature(s) will cause a reliability issue for the device and therefore if those patterned feature(s) are reliability defects. For example, the sub-threshold leakage current for a patterned feature may be compared to a threshold that separates acceptable sub-threshold leakage current values from sub-threshold leakage current values that may be problematic for the device. Patterned features having values on the problematic side of that threshold may be identified as reliability defects. Determining which patterned features will cause reliability defects based on the device characteristic(s) determined for the patterned features may be performed in any other suitable manner.

Identifying patterned features that will cause reliability defects may not necessarily include determining quantitatively the device characteristic(s) based on the patterned feature characteristic(s). For example, the method may include using a method, algorithm, function, or equation to determine acceptable values of the one or more characteristics of the patterned features based on acceptable values of the one or more device characteristics. In this manner, when the patterned feature characteristic(s) are determined as described herein, they may be compared to the acceptable values. Patterned features having characteristic(s) outside of the acceptable values may be identified as reliability defects, and patterned features that do not have characteristic(s) outside of the acceptable characteristics may not be identified as reliability defects.

In one such embodiment, the one or more patterned features include one or more structures of one or more transistors of the device, and the one or more characteristics of the device include leakage current. In this manner, the embodiments described herein may focus on the impact of transistor characteristic variations such as those described above on leakage current. Leakage current is the unintended loss of electrical current at the transistor level. For example, leakage current can be carried by tunneling electrons (e.g., via direct tunneling from gate to channel or from gate to source and drain). Gate leakage can be due to ultra-thin gate oxide for gate tunneling. In addition, a high K dielectric material can be thicker to reduce gate oxide leakage current.

Leakage current depends on doping, gate oxide thickness, channel critical dimension (CD), and layout in a complex way. From device physics theory, the sub-threshold “off” leakage current increases with decreased channel length, and it has direct dependence on W/L. The sub-threshold “off” leakage current also increases exponentially when threshold voltage is reduced, and the sub-threshold “on” leakage current decreases with temperature while the sub-threshold “off” leakage current increases with temperature. In addition, layout has a direct relationship with leakage current. The same gate W and L but with different source/drain area and perimeter can result in different leakage current. In addition, the leakage current increases exponentially as the number of transistors increases in smaller technology nodes.

From a processing point of view, leakage current has a highly nonlinear dependence on parameters that are subject to process variability. For example, lithography and etch variability can cause variability in the channel L, W/L, W*L, area of the source (AS), area of the drain (AD), perimeter of the source (PS), and perimeter of the drain (PD). In addition, local (intra-die) variability in lithography and etch can cause the sum of the sub-threshold leakage “off” current to increase accordingly. Furthermore, the lithography and etch variability can have a direct impact on the sub-threshold “on” and “off” currents via the threshold voltage (the short channel effect). In another example, variability in the thickness of a gate oxide can directly impact the sub-threshold “on” and “off” leakage currents (via the capacitance of the oxide). In addition, variability in the thickness of a gate oxide can indirectly affect the sub-threshold “on” and “off” leakage currents (via the threshold voltage since the threshold voltage depends on the capacitance of the oxide). In an additional example, variability in the doping concentration and profile can have an indirect impact on the sub-threshold “on” and “off” leakage currents via the threshold voltage, L, and the body effect.

In another such embodiment, the one or more patterned features include one or more structures of one or more interconnect vias of the device, and the one or more characteristics of the device include resistance. In this manner, the embodiments described herein may focus on the impact of interconnect via characteristic variations such as those described above on resistance. Vias are process-sensitive, layout specific interconnect reliability elements. Via CD variation affects its resistance. In one such example, via resistance increases with reduced via area of cross section. The higher resistance exhibits a higher early failure rate. In addition, different via sizes at the top of vias compared to the bottom of vias may indicate via healthiness. Size differential for vias can be determined as the size of the vias at the top subtracted from the size of the vias at the bottom. Furthermore, open failures (infinite resistance) may occur due to lack of anchor formation.

A resistance index can be determined for the vias as the difference between the area of the top of the vias measured on the wafer subtracted from the area of the top of the vias in the design for the wafer (i.e., ΔArea (top)), which may be determined as described herein, divided by the difference between the area of the bottom of the vias measured on the wafer subtracted from the area of the bottom of the vias in the design for the wafer (i.e., ΔArea (top)), which may be determined as described herein. In this manner, resistance index=ΔArea (top)/ΔArea (bottom). The change in area of the vias can be used to map out interconnect resistance index with respect to via types. The interconnect vias for which the embodiments described herein are performed may include any known interconnect vias such as isolated, semi-isolated, dense, and redundant.

From a processing point of view, variability in the via size can be caused by variability in lithography and etch. Therefore, in some embodiments, the output that is generated by the inspection system and used as described herein may include output generated after develop (i.e., in an after develop inspection (ADI)) or after etch (i.e., in an after etch inspection (AEI)).

In one embodiment, the method is performed inline during fabrication of the device on the wafer and prior to completion of the fabrication of the device on the wafer. In this manner, the embodiments described herein can be used to detect inline wafer reliability defects (including latent reliability defects) using various tools such as BBP wafer inspection tools and electron beam defect review tools. In contrast, today, users depend on end of line testing to discover reliability issues. The approaches described herein, however, provide in-line discovery solutions that will significantly reduce the reliability-related yield learning cycle.

The embodiments described herein also extend the capability of inspection tools to reliability defect detection, compared to the traditional use cases of inspection tools (e.g., physical defect detection). For example, typically, wafer inspection tools are used to detect physical defects such as systematic defects, which may be caused by a process-design interaction, and random defects caused by process variability. In this manner, the wafer inspection tools can be used to reduce defect-limited yield loss. However, reliability defects caused by process variability can also impact yield. As described herein, wafer inspection tools can be adapted to detect process variability that affects leakage and resistance. In addition, the embodiments described herein can be used to detect all kinds of process variability, all leakage components, and all interconnect components. As such, the embodiments described herein can be used to extend wafer inspection tool capability to reliability-related yield loss reduction. Therefore, the embodiments described herein can be used to reduce, and even eliminate, a major problem caused by process variability.

As mentioned above, the embodiments described herein can be used to detect reliability defects caused by many if not all of the process variabilities that may occur during chip fabrication. For example, the embodiments described herein can be used to detect defects in the gate oxide layer (especially at the silicon/oxide interface) and trapped charges, which can increase leakage current, shift the threshold voltage, and cause performance degradation over time. In another example, the embodiments described herein can be used to detect defects and voids caused by the rapid thermal processing (RIP) gate anneal step. In addition, the embodiments described herein can be used to detect decreased channel lengths (e.g., due to voids, over-etching, etc.) caused by the polysilicon lithography, polishing, and etching steps. In a further example, the embodiments described herein can be used to detect decreased channel length due to lateral spread of the source and/or drain implants under the gate (e.g., due to undercut, etc.), which may occur due to the source/drain implant step. In yet another example, the embodiments described herein can be used to detect defects caused by the spacer deposition and etch processes, which control how close the source and drain are to the channel (e.g., the narrower the spacer, the closer the source/drain are to the gate channel). Furthermore, the embodiments described herein can be used to detect defects caused by decreased channel lengths due to the RTP source/drain step (e.g., as time or temperature in the RTP source/drain step increases, the lateral diffusion increases thereby shrinking channel length). In addition, the embodiments described herein can be used to detect defects caused by the shallow trench etch step, which may cause damage and/or defects that will create defect-related leakage paths.

In another embodiment, the method includes acquiring output for the wafer generated by a defect review system at one or more locations on the wafer at which at least one of the one or more identified patterned features is formed, overlaying design data for the at least one identified patterned feature with the output generated by the defect review system for the at least one identified patterned feature, determining one or more differences between the at least one identified patterned feature formed on the wafer and the design data for the at least one identified patterned feature, and determining if the at least one identified patterned feature is a reliability defect based on the determined one or more differences. The defect review system used to generate the output for the wafer may be configured as described further herein. For example, the defect review system may be an electron beam-based defect review system (i.e., an eDR tool or a SEM), which may include any suitable commercially available electron beam defect review system. Taking the device physics theory described above to wafer processing, the quantitative value of ΔL, ΔW/L, and ΔArea of a via may be extracted from SEM-GDS overlay analysis (for the top and/or bottom of the vias), and wafer defects may be classified as reliability defects (void, undercut, over-etch) at front end of line (FEOL) stacks.

In a further embodiment, the method includes determining a wafer level spatial distribution of the identified one or more patterned features. For example, leakage signature and via resistance index can be reported and displayed as a color die map for wafer level spatial distribution.

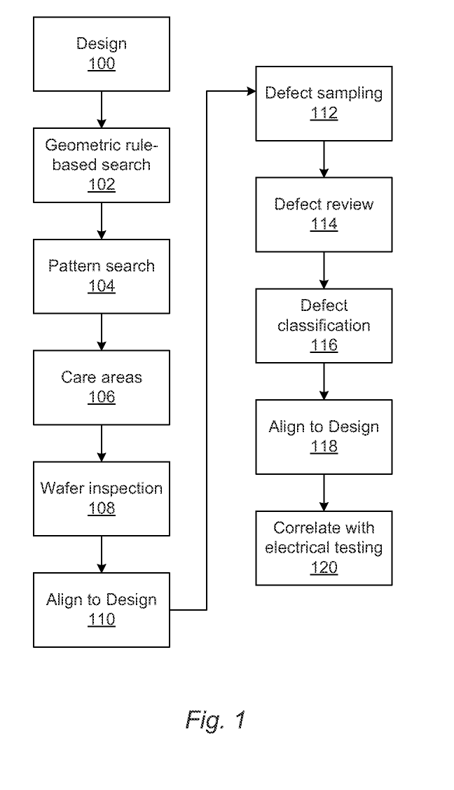

In some embodiments, the method includes generating care areas on the wafer for the determining and identifying steps by applying a geometric rule-based search to design data for the wafer, searching the design data for instances of patterns identified by the geometric rule-based search, and designating areas in the design data containing the instances of the patterns as the care areas. Therefore, the embodiments described herein may include a geometric rule-based search to generate care areas based on foundry device parameters. For example, in the embodiment of the wafer leakage signature discovery flow shown in FIG. 1, design 100 may be input to geometric rule-based search 102. Design 100 may include any of the designs or design data described herein. Therefore, the design may include device parameters (foundry) or design GDS. The geometric rule-based search may be performed based on any of the patterned feature characteristics described herein such as L, W, W/L, PD/PS, AS/AD, or any combination thereof. The geometric rule-based search may also be performed based on the device rule for any of the above-described patterned feature characteristics and/or information about the electrical testing that is to be performed on the wafer. For example, the geometric rule-based search may be configured to identify those features on the wafer that will be electrically tested since presumably the device designer and/or electrical testing engineer is at least somewhat concerned about their reliability (otherwise they would not need to be tested). The geometric rule-based search may also be performed based on multi-layer design data (such that patterned features on more than one layer can be considered together when identifying patterns of interest). In addition, the rule based search may be performed based on the types of gates that will be formed from the patterned features and/or the types of interconnect vias that will be formed from the patterned features.

As further shown in FIG. 1, the results of geometric rule-based search 102 may be used for pattern search 104. In this pattern search step, the entire design or design data may be searched for patterns identified by the geometric rule-based search. Therefore, pattern search 104 may be performed to search for multiple instances of the patterns that are identified by the geometric rule-based search as being potentially problematic. In addition, the pattern search may be performed to find all variants of POIs in a device. Any of the steps described herein as involving searching for patterns, pattern matching, or overlaying patterns may be performed using the NanoPoint product that is commercially available from KLA-Tencor or any other suitable method and/or algorithm for aligning one pattern to another (e.g., aligning a pattern in an image of a wafer to a pattern in a design for the wafer). In addition, aligning two patterns may be performed in the steps described herein as described in U.S. Pat. No. 7,676,077 issued on Mar. 9, 2010 to Kulkarni et al., which is incorporated by reference as if fully set forth herein.

As also shown in FIG. 1, the method may include generating care areas 106. The care areas may be front end of line (FEOL) care areas for the full stack of the chips being formed on the wafer. The care areas may have a size that would make referring to them as “micro-care areas” appropriate. For example, the care areas may have a size of about 100 nm to about 200 nm. As noted above, the care areas may be areas in the design and corresponding areas on the wafer containing the patterned features identified by the geometric rule-based search and the pattern searching steps.

In an additional embodiment, the method includes identifying portions of the output corresponding to care areas on the wafer by searching for patterns in the output, and the determining step is only performed for the portions of the output corresponding to the care areas. In the embodiments described herein that use care areas, the results of the embodiments may be reported as a function of the various care areas. In another embodiment, the output on which the determining step is based includes local intensity of light from the wafer detected by the inspection system. For instance, the embodiments may include reporting local intensity as a function of care area. In addition, the raw intensity per care area may be the output of the wafer inspection system that is used in the embodiments described herein.

In one such embodiment, the method may include, as shown in FIG. 1, wafer inspection 108, which may be performed based on the care areas generated in step 106. For instance, output that is only generated in portions of the wafer corresponding to the care areas may be acquired and used by the methods described herein. In this manner, the steps of the embodiments described herein may only be performed for the output corresponding to the care areas. Wafer inspection step 108 may be further performed as described herein with any of the wafer inspection systems described herein.

As further shown in FIG. 1, the method may include align to design step 110. In this step, design-based classification (DBC) may be performed to generate different bins that correspond to different, unique patterns of interest (POIs). In this manner, the output generated for the wafer at locations of similar POIs on the wafer can be binned into the same group or bin. The POIs used for this step may be any of the POIs identified by any of the steps described herein or from test patterns or structures and from rules (e.g., via the geometric rule-based search described above). In addition, the embodiments described herein may include performing one or more other steps based on the results of such DBC including, for example, determining a signature distribution of the patterned features in any one or more of the bins across the wafer. A leakage signature and resistance index distribution determined as described herein may be output in any suitable manner (e.g., a color die map).

In another embodiment, the method includes selecting at least one of the one or more identified patterned features for defect review. For example, as shown in FIG. 1, the method may include defect sampling 112. In this step, defects of interest may be sampled for eDR by determining which of the patterns of interest have been identified as reliability defects and then sampling one or more of the patterns of interest from each of the bins described above. In addition, in some instances, one or more patterns of interest may be sampled from each of the bins regardless of whether they were identified as reliability defects. In this manner, the results of the identification step can be verified or corrected by defect review (e.g., by determining if identified reliability defects are really reliability defects and vice versa).

In some embodiments, the method includes acquiring output of a defect review system for at least one of the one or more identified patterned features and classifying the at least one identified patterned feature based on the output acquired from the defect review system. For example, as shown in FIG. 1, the method may include defect review step 114, which may be performed as described herein using any of the defect review systems described herein. In addition, the method may include defect classification step 116, in which defect classifications may be determined for any of the defects that were reviewed in step 114 or detected in step 108. For example, the defects may be classified as leakage related reliability defects, electrical defects, physical defects, etc. As further shown in FIG. 1, the method may include align to design step 118, which may include the SEM image to GDS overlay analysis described further herein.

In one embodiment, the method includes determining a correlation between the determined one or more characteristics and results of electrical testing of the wafer. For example, the gate leakage signature and resistance index determined as described herein can be directly correlated to electrical testing leakage current and resistance data. The embodiments described herein provide more accurate quantitative relationships between reliability defects and electrical testing leakage current and interconnect resistance data. For example, as shown in FIG. 1, the method may include correlate with electrical testing step 120. This step may include determining a correlation with electrical testing parameters. The results of the electrical testing correlation may be output in any suitable format (e.g., a table, die map, etc.). The embodiment shown in FIG. 1 may include any other step(s) described herein.

In an additional embodiment, the method includes determining one or more corrections for one or more processes performed on the wafer based on the identified one or more patterned features. The embodiments described herein help better understand the root causes of reliability issues for corrective actions. In addition, the embodiments described herein are advantageous because they can determine corrective actions that can mitigate the reliability defects described herein, which can have a dramatic impact on the devices fabricated on wafers. For example, as leakage current increases, more power is required to operate an IC chip thereby escalating power consumption. In addition, as leakage current increases, the chip will generate more heat thereby escalating environmental concerns. Furthermore, as leakage current increases, the IC chip performance will be degraded thereby necessitating the removal of excess heat which will increase the capital expenditures of chip fabrication. Moreover, leakage current cannot be eliminated and can only be reduced at a price. However, the embodiments described herein provide a cost effective solution to detecting reliability defects such as leakage current and determining corrective actions for reducing leakage current. As such, the embodiments described herein can be used to reduce chip power consumption, reduce environmental concerns, and reduce capital expenditures of chip fabrication.

In addition to the advantages to the embodiments described herein, the embodiments described herein provide even more significant advantages as the scale of ICs decreases. For example, scaling causes less reliable electronics. In particular, scaling causes more leakage current (including gate leakage current and subthreshold “off” leakage current). Furthermore, as the physical gate length decreases exponentially over time, the gate oxide leakage and sub-threshold leakage increase exponentially over time. In addition, interconnect speed is becoming a performance bottleneck (higher resistance, capacitance). Therefore, dimension-dependent effects dramatically influence the device reliability.

The acquiring, determining, and identifying steps described herein are performed by a computer system, which may be configured as described further herein.

Each of the embodiments of the method described above may include any other step(s) of any other method(s) described herein. Furthermore, each of the embodiments of the method described above may be performed by any of the systems described herein.

All of the methods described herein may include storing results of one or more steps of the method embodiments in a computer-readable storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc.

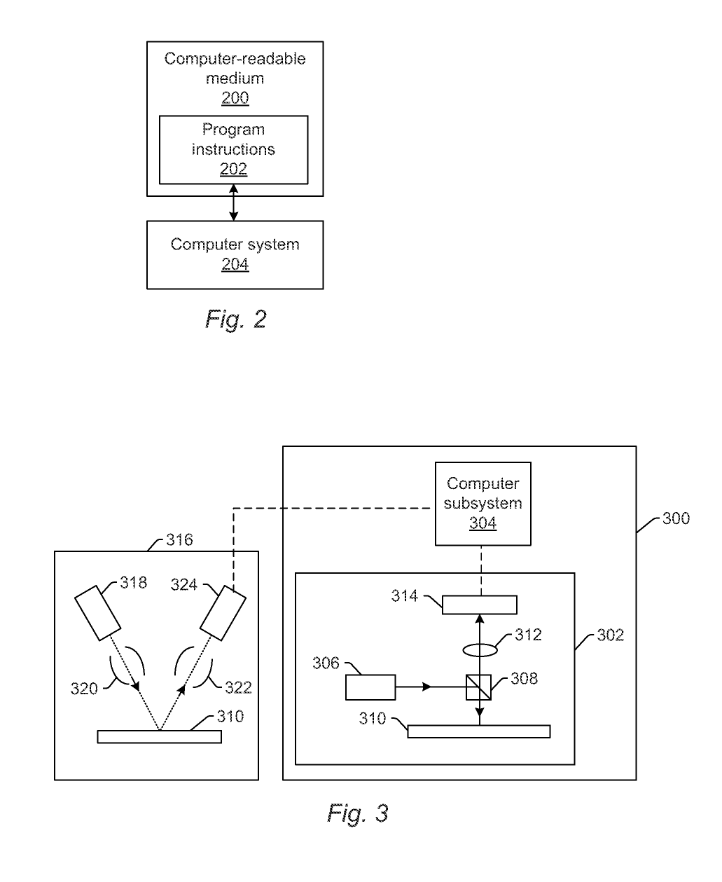

An additional embodiment relates to a non-transitory computer-readable medium storing program instructions executable on a computer system for performing a computer-implemented method for detecting reliability defects on a wafer. One such embodiment is shown in FIG. 2. In particular, as shown in FIG. 2, computer-readable medium 200 includes program instructions 202 executable on computer system 204. The computer-implemented method includes the steps of the method described above. The computer-implemented method for which the program instructions are executable may include any other step(s) described herein.

Program instructions 202 implementing methods such as those described herein may be stored on computer-readable medium 200. The computer-readable medium may be a storage medium such as a magnetic or optical disk, or a magnetic tape or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), or other technologies or methodologies, as desired.

The computer system may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer system may also include any suitable processor known in the art such as a parallel processor. In addition, the computer system may include a computer platform with high speed processing and software, either as a standalone or a networked tool.

An additional embodiment relates to a system configured to detect reliability defects on a wafer. One embodiment of such a system is shown in FIG. 3. System 300 includes inspection subsystem 302 configured to generate output for a wafer, which is configured in this embodiment as described further herein. The system also includes computer subsystem 304 configured for performing the determining and identifying steps described herein. The computer subsystem may be configured to perform these steps according to any of the embodiments described herein. The computer subsystem and the system may be configured to perform any other step(s) described herein and may be further configured as described herein.

The inspection subsystem may be configured to generate the output for the wafer by scanning the wafer with light and detecting light from the wafer during the scanning. For example, as shown in FIG. 3, the inspection subsystem includes light source 306, which may include any suitable light source known in the art. Light from the light source may be directed to beam splitter 308, which may be configured to direct the light from the light source to wafer 310. The light source may be coupled to any other suitable elements (not shown) such as one or more condensing lenses, collimating lenses, relay lenses, objective lenses, apertures, spectral filters, polarizing components and the like. As shown in FIG. 3, the light may be directed to the wafer at a normal angle of incidence. However, the light may be directed to the wafer at any suitable angle of incidence including near normal and oblique incidence. In addition, the light or multiple light beams may be directed to the wafer at more than one angle of incidence sequentially or simultaneously. The inspection subsystem may be configured to scan the light over the wafer in any suitable manner.

Light from wafer 310 may be collected and detected by one or more channels of the inspection subsystem during scanning. For example, light reflected from wafer 310 at angles relatively close to normal (i.e., specularly reflected light when the incidence is normal) may pass through beam splitter 308 to lens 312. Lens 312 may include a refractive optical element as shown in FIG. 3. In addition, lens 312 may include one or more refractive optical elements and/or one or more reflective optical elements. Light collected by lens 312 may be focused to detector 314. Detector 314 may include any suitable detector known in the art such as a charge coupled device (CCD) or another type of imaging detector. Detector 314 is configured to generate output that is responsive to the reflected light collected by lens 312. Therefore, lens 312 and detector 314 form one channel of the inspection subsystem. This channel of the inspection subsystem may include any other suitable optical components (not shown) known in the art.

Since the inspection subsystem shown in FIG. 3 is configured to detect light specularly reflected from the wafer, the inspection subsystem is configured as a BF inspection subsystem. Such an inspection subsystem may, however, also be configured for other types of wafer inspection. For example, the inspection subsystem shown in FIG. 3 may also include one or more other channels (not shown). The other channel(s) may include any of the optical components described herein such as a lens and a detector, configured as a scattered light channel. The lens and the detector may be further configured as described herein. In this manner, the inspection subsystem may also be configured for DF inspection.

Computer subsystem 304 is coupled to the inspection subsystem such that output generated by the detector(s) during scanning may be provided to computer subsystem 304. For example, the computer subsystem may be coupled to detector 314 (e.g., by one or more transmission media shown by the dashed line in FIG. 3, which may include any suitable transmission media known in the art) such that the computer subsystem may receive the output generated by the detector.

The computer subsystem may be configured to perform any step(s) described herein. For example, computer subsystem 304 may be configured for performing the determining and identifying steps as described herein. In addition, computer subsystem 304 may be configured to perform any other steps described herein. The computer subsystem may also be configured as a virtual inspector such as that described in U.S. Pat. No. 8,126,255 issued on Feb. 28, 2012 to Bhaskar et al., which is incorporated by reference as if fully set forth herein.

The system shown in FIG. 3 may also include a defect review system configured to generate output for a wafer as described further herein. In the embodiment of the system shown in FIG. 3, the defect review system is shown as an electron beam defect review system. However, the defect review system may include any other suitable defect review system known in the art. The defect review system shown in FIG. 3 includes electron column 316 coupled to computer subsystem 304. Therefore, the defect review system may be coupled to the inspection system via the computer subsystem of the inspection system. However, the defect review system may also include a computer subsystem and the computer subsystems of the inspection and defect review systems may be coupled to send information between the two computer subsystems. The electron column and the computer subsystem or the two computer subsystems may be coupled in this manner as described further herein (e.g., via one or more transmission media).

The electron column includes electron beam source 318 configured to generate electrons that are focused to wafer 310 by one or more elements 320. The electron beam source may include, for example, a cathode source or emitter tip, and one or more elements 320 may include, for example, a gun lens, an anode, a beam limiting aperture, a gate valve, a beam current selection aperture, an objective lens, and a scanning subsystem, all of which may include any such suitable elements known in the art. Electrons returned from the wafer (e.g., secondary electrons) may be focused by one or more elements 322 to detector 324. One or more elements 322 may include, for example, a scanning subsystem, which may be the same scanning subsystem included in element(s) 320. The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein. Although the electron column is shown in FIG. 3 as being configured such that the electrons are directed to the wafer at an oblique angle of incidence and are scattered from the wafer at another oblique angle, it is to be understood that the electron beam may be directed to and scattered from the wafer at any suitable angles.

Computer subsystem 304 may be coupled to detector 324 as described above. The detector may detect electrons returned from the surface of the wafer thereby forming images of the wafer. The images may include any of the electron beam images described herein. Computer subsystem 304 may be configured to perform any step(s) described herein using the electron beam images.

It is noted that FIG. 3 is provided herein to generally illustrate a configuration of an inspection system and defect review system that may be included in the system embodiments described herein. Obviously, the inspection and defect review system configurations described herein may be altered to optimize the performance of the inspection system and defect review system as is normally performed when designing commercial inspection and defect review systems. In addition, the systems described herein may be implemented using an existing inspection system and/or existing defect review system (e.g., by adding functionality described herein to an existing inspection or defect review system) such as the 29xx/28xx series of tools that are commercially available from KLA-Tencor, Milpitas, Calif. For some such systems, the methods described herein may be provided as optional functionality of the system (e.g., in addition to other functionality of the system). Alternatively, the system described herein may be designed “from scratch” to provide a completely new system.

Further modifications and alternative embodiments of various aspects of the invention will be apparent to those skilled in the art in view of this description. For example, methods and systems for detecting reliability defects on a wafer are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed:

1. A computer-implemented method for detecting reliability defects on a wafer, comprising:
acquiring output for a wafer generated by an inspection system;
determining one or more characteristics of one or more patterned features formed on the wafer based on the output; and
identifying which of the one or more patterned features will cause one or more reliability defects in a device being formed on the wafer based on the determined one or more characteristics, wherein said acquiring, said determining, and said identifying are performed by a computer system.

2. The method of claim 1, wherein the inspection system is a light-based inspection system, and wherein a light source of the inspection system used for said acquiring is a broadband plasma light source.

3. The method of claim 1, wherein the method is performed inline during fabrication of the device on the wafer and prior to completion of the fabrication of the device on the wafer.

4. The method of claim 1, wherein said identifying comprises determining one or more characteristics of the device based on the determined one or more characteristics of the one or more patterned features and determining if the one or more characteristics of the device will cause a reliability defect in the device.

5. The method of claim 4, wherein the one or more patterned features comprise one or more structures of one or more transistors of the device, and wherein the one or more characteristics of the device comprise leakage current.

6. The method of claim 4, wherein the one or more patterned features comprise one or more structures of one or more interconnect vias of the device, and wherein the one or more characteristics of the device comprise via resistance.

7. The method of claim 1, wherein the one or more patterned features comprise one or more structures of one or more transistors of the device, and wherein the one or more determined characteristics comprise a dimension of a gate, an area of a source or drain, a perimeter of the source or drain, or a combination thereof.

8. The method of claim 1, wherein the one or more patterned features comprise one or more structures of one or more interconnect vias of the device, and wherein the one or more determined characteristics comprise interconnect via enclosure or area.

9. The method of claim 1, wherein the determined one or more characteristics comprise one or more differences between one or more measured values of the one or more characteristics of the one or more patterned features formed on the wafer and one or more designed values of the one or more characteristics of the one or more patterned features in a design for the wafer.

10. The method of claim 1, further comprising acquiring output for the wafer generated by a defect review system at one or more locations on the wafer at which at least one of the one or more identified patterned features is formed; overlaying design data for the at least one identified patterned feature with the output generated by the defect review system for the at least one identified patterned feature; determining one or more differences between the at least one identified patterned feature formed on the wafer and the design data for the at least one identified patterned feature; and determining if the at least one identified patterned feature is a reliability defect based on the determined one or more differences.

11. The method of claim 1, further comprising determining a correlation between the determined one or more characteristics and results of electrical testing of the wafer.

12. The method of claim 1, wherein the output on which the determining step is based comprises local intensity of light from the wafer detected by the inspection system.

13. The method of claim 1, further comprising determining a wafer level spatial distribution of the identified one or more patterned features.

14. The method of claim 1, further comprising generating care areas on the wafer for the determining and identifying steps by: applying a geometric rule-based search to design data for the wafer; searching the design data for instances of patterns identified by the geometric rule-based search; and designating areas in the design data containing the instances of the patterns as the care areas.

15. The method of claim 1, further comprising identifying portions of the output corresponding to care areas on the wafer by searching for patterns in the output, wherein the determining step is only performed for the portions of the output corresponding to the care areas.

16. The method of claim 1, further comprising selecting at least one of the one or more identified patterned features for defect review.

17. The method of claim 1, further comprising acquiring output of a defect review system for at least one of the one or more identified patterned features and classifying the at least one identified patterned feature based on the output acquired from the defect review system.

18. The method of claim 1, further comprising determining one or more corrections for one or more processes performed on the wafer based on the identified one or more patterned features.

19. A non-transitory computer-readable medium, storing program instructions executable on a computer system for performing a computer-implemented method for detecting reliability defects on a wafer, wherein the computer-implemented method comprises:
acquiring output for a wafer generated by an inspection system;
determining one or more characteristics of one or more patterned features formed on the wafer based on the output; and
identifying which of the one or more patterned features will cause one or more reliability defects in a device being formed on the wafer based on the determined one or more characteristics.

20. A system configured to detect defects on a wafer, comprising:
an inspection subsystem configured to generate output for a wafer; and
a computer subsystem configured for:
determining one or more characteristics of one or more patterned features formed on the wafer based on the output; and
identifying which of the one or more patterned features will cause one or more reliability defects in a device being formed on the wafer based on the determined one or more characteristics.
